(19) United States
(12) Patent Application Publication
(10) Pub. No.: US 2005/0001438 A1
(43) Pub. Date: Jan. 6, 2005

(54) Robotic arm for preventing electrostatic damage

(76) Inventors: Yu-Chou Lee, Taipei Hsien (TW); Ying-Ming Wu, Taoyuan City (TW); Chien-Yu Chen, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/772,712

(22) Filed: Feb. 5, 2004

(30) Foreign Application Priority Data
Jul. 2, 2003 (TW) 92118117

(51) Int. Cl. B65G 49/07

(52) U.S. Cl. 294/1.1

(57) ABSTRACT

A robotic arm that has a main body and pads thereon can prevent electrostatic damage. These pads are used to carry substrates between and in processing machines. A material of these pads is the same as or similar to the material of the substrate to lower the amount of the electrostatic charges produced during the manufacturing process. Therefore, the electrostatic charges cannot damage the electronic devices on the substrate.

### BACKGROUND OF THE INVENTION

1. Field of the Invention

The present invention relates to a device for manufacturing liquid crystal display. More particularly, the present invention relates to a robotic arm for preventing electrostatic damage.

2. Description of Related Art

Liquid crystal display (LCD) has many advantages over other conventional types of displays including high picture quality, small volume occupation, light weight, low voltage drive and low power consumption. Hence, LCD is widely used in small portable televisions, mobile telephones, video recording units, notebook computers, desktop monitors, projector televisions and so on. LCD is gradually replacing the conventional cathode ray tube (CRT) as a mainstream display unit.

Since the “ON” and “OFF” states of each pixel in a LCD are respectively controlled by each thin film transistor (TFT) on the TFT array substrate, the electrical features, such as threshold voltage, of a TFT are very important to the display quality of the LCD. Usually, electrostatic charges are accumulated on a substrate during manufacturing processes for various reasons. If the accumulated amount of the electrostatic charges is too large, the TFTs are often damaged by the accumulated electrostatic charges. Therefore, a plasma sprayer is often used to spray charged particles on a substrate to neutralize the accumulated electrostatic charges. However, the effect is very limited, and product yields cannot be effectively increased.

### SUMMARY OF THE INVENTION

In one aspect, the present invention provides a robotic arm for preventing electrostatic damage to decrease electrostatic charges accumulation on a substrate, whereby the damage of electronic devices on the substrate can be minimized.

In accordance with the foregoing and other aspects of the present invention, a robotic arm for preventing electrostatic damage is provided. The robotic arm has a main body and pads. These pads are allocated on the main body for loading a substrate. A material of the pads is the same as or similar to that of the substrate to avoid damaging electronic devices on the substrate with electrostatic charges generated by friction during the manufacturing process. For example, if the substrate is made of glass, the pads can be made of glass or quartz.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a top view of a robotic arm carrying a substrate according to a preferred embodiment of the present invention; and

FIG. 2 is a diagram showing a top view of a robotic arm according to a preferred embodiment of the present invention.

### DESCRIPTION OF THE PREFERRED EMBODIMENTS

Reference will now be made in detail to a preferred embodiment of the invention, examples of which are illustrated in the accompanying drawings. Wherever possible, the same reference numbers are used in the drawings and the description to refer to the same or like parts.

As described above, since the effect of using a plasma sprayer to spray plasma on a substrate to neutralize the accumulated electrostatic charges is very limited, the electrostatic source damaging electrical devices may not come from the top surface but from the bottom surface, which cannot be easily reached by the sprayed plasma, of a substrate. Therefore, a resolution from the bottom surface of a substrate would be preferable.

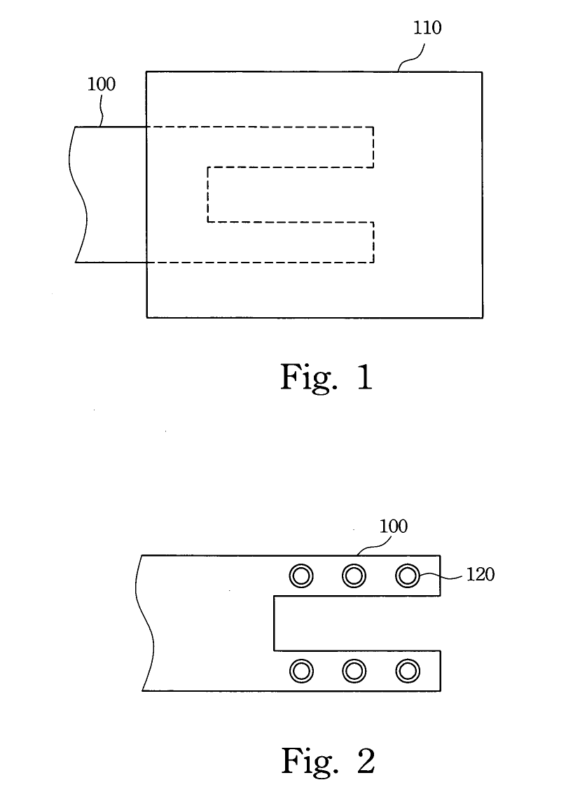

Generally speaking, a substrate is transported between various reaction chambers by various types of robotic arms. Only friction is utilized to fix a substrate on a robotic arm to avoid the substrate being displaced and falling from the robotic arm. FIG. 1 is a diagram showing a top view of a robotic arm carrying a substrate. In FIG. 1, a robotic arm 100 is used to carry a substrate 110 to transport the substrate between reaction chambers. Hence, series of manufacturing processes can be performed to accomplish a LCD.

FIG. 2 is a diagram showing a top view of a robotic arm. In FIG. 2, several pads 120 are usually allocated on a robotic arm 100, and a substrate is placed on the pads 120. Pads 120 are made of a conductive material, Celazolu, to disperse the electrostatic charges for decreasing the electrostatic density. The substrate 110 relies on the friction force with the pads 120 to fix itself on the pads 120. Hence, the surface roughness of the pads 120 at least has to maintain a maximum static friction force above 1.2 Kg. If the maximum static friction force for the surface roughness of the pads 120 is less than 1.2 Kg, the pads 120 have to be replaced to prevent the substrate 110 falling from the robotic arm 100 if the substrate 110 moves.

During the inspection process for finding the problem, a substrate having electronic devices is firstly sectioned to get samples, and scanning electron microscopy (SEM) and focus ion beam (FIB) are used to scan the samples. From the scanning images of the samples, volcanoes caused by large electric current are found toward the bottom of the samples, and the sources of the electrostatic damage hence are inferred to result from the electrostatic charges produced by the friction forces during the transport process. When the electrostatic charges accumulate to a certain amount, the electrostatic currents occur and penetrate the substrate, and the electronic devices are thus affected or damaged.

The principle of generating electrostatic charges by rubbing is described as follows. When relative motion occurs between two objects, the relative motion speed is slowed down by collisions between boundary molecules of the two objects. Hence, the kinetic energy is transformed to deformed potential energy and then heat energy of the two objects. During a violent collision process, the bound electrons of the boundary molecules are often excited to become free electrons. Most of these free electrons return to their original molecules. However, some of these free electrons may attach to the other object. Therefore, if the two objects are made of the same material, the opportunities for gaining or losing electrons for the two objects are the same, and the two objects are thus neutral after rubbing. If one object is more easily excited than the other object to generate free electrons, this object is electrically positive after rubbing since its electrons remain attached to the other object.

In light of foregoing, if the pads are made of material the same as or similar to that of the substrate, the electrostatic damage problem, as described above, might be resolvable. For example, if a material of a substrate is glass, the pads can be made of glass or quartz. Hence, in a preferred embodiment of this invention, the pads of the robotic arm are made of glass for carrying a glass substrate. The experimental results are listed in Table 1. Usually, a substrate can be divided into several panels according to the size needed for the panels. For example, a substrate can be divided into six 15-inches panels. In Table 1, when the pads are made of material the same as or similar to that of the substrate, the defect percentage is decreased from 87.5% to 16.7%.

TABLE 1

| | Panel | | |
|---|---|---|---|
| | defect number | Panel total number | Defect percentage |
| Celazolu pads | 35 | 40 | 87.5% |
| Glass pads | 1 | 6 | 16.7% |

From the preferred embodiment of this invention, when a material the same as or similar to that of a substrate is used to fabricate the pads, the amount of the electrostatic charges can be largely decreased and the defect percentage can thus be largely reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A robotic arm for preventing electrostatic damage and applied in manufacturing liquid crystal display, the robotic arm comprising:
a main body; and
pads allocated on the main body to load a substrate, wherein a material of the pads is identical to that of the substrate.

2. A robotic arm for preventing electrostatic damage and applied in manufacturing liquid crystal display, the robotic arm comprising:
a main body; and
pads allocated on the main body to load a substrate, wherein a material of the pads is similar to that of the substrate to avoid damaging electronic devices on the substrate by electrostatic charges generated by friction during the manufacturing process.

3. The robotic arm of claim 2, wherein the material of the pads is quartz when the material of the substrate is glass.

4. An improved robotic arm for preventing electrostatic damage, the robotic arm comprising a main body and pads allocated on the main body to load a substrate, wherein the improvement comprises:
a material of the pads being identical to that of the substrate.

5. An improved robotic arm for preventing electrostatic damage, the robotic arm comprising a main body and pads allocated on the main body to load a substrate, wherein the improvement comprises:
a material of the pads being similar to that of the substrate to avoid damaging electronic devices on the substrate by electrostatic charges generated by friction during the manufacturing process.

6. The robotic arm of claim 5, wherein the material of the pads is quartz when the material of the substrate is glass.
